(19) United States
(12) Patent Application Publication
(10) Pub. No.: US 2007/0111571 A1
(43) Pub. Date: May 17, 2007

(54) Assembled method of an electrical connector

(75) Inventors: Jian-Feng Shen, ShenZhen (CN); Wen He, ShenZhen (CN); Yao-Chi Huang, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/599,853

(22) Filed: Nov. 14, 2006

(30) Foreign Application Priority Data
Nov. 14, 2005 (TW) 94139849

(51) Int. Cl. H01R 13/62

(52) U.S. Cl. 439/157

(57) ABSTRACT

An assembled method about an electrical connector comprises the following steps: A. providing a housing received a plurality of terminals and defined a housing hole; B. providing a cover defined a cover hole thereof; C. mounting the cover on the housing and making the housing hole in alignment with the cover hole; D. providing a cam defined a end surface and a riveting plate for riveting the cam; E. inserting the cam into the cover hole, the housing hole and riveting hole in turn; F. using the pressing header riveting the end surface of the cam; in addition, the assemble method further comprises the step G: defining a recess with the shape similar to the shape of the pressing header.

### BACKGROUND OF THE INVENTION

1. Field of the Invention

The present invention is related to an assembled method of an electrical connector, and particularly to an assembled method used for installing an electrical connector for connecting a chip module to a printed circuit board.

2. Description of the Prior Art

Electrical connectors are widely used for electrically connecting electronic packages such as integrated circuits (ICs) with printed circuit boards. Referring to FIGS. 1 and 2, a typical electrical connector 100′ comprises an insulative housing 6′, a number of electrical contacts 5′ (not shown) received in the housing 6′, a cover 7′ mounted on the housing 6′, a cam 8′ for actuating the cover 7′ moving relative to the housing 6′, a washer 9′ and a riveting plate 10′ for engaging with the cam 8′. The cam 8′ engages with washer 9′ by a rivet technology, in this case, the cam 8′ can actuate the cover 7′ moving relative to the housing 6′ between a first position and a second position, wherein the first position is a position that leads of the chip module inserted into corresponding passageways of the housing 6′ and not abutting against the terminals 5′, the second position is a position that leads of the chip module inserted into the corresponding passageways of the housing 6′ and abutting against the terminals 5′.

The housing 6′ and the cover 7′ each define a receptacle hole 610′, 710′ respectively for receiving a corresponding portions of cam 8′.

The cam 8′ comprises a plurality of column with a decreasing diameter in an upper to lower direction. The riveting plate 10′ defines a receiving section 101′ for engaging with a corresponding portion of the cam 8′.

During assembly of the electrical connector 100′, the cam 8′ passes through the receptacle hole 710′ of the cover 7′, the washer 9′, the hole 610′ of the housing 6′ and protrudes outwardly. And then the portion protruding from the housing 6′ rivets with riveting plate 10′, hence the cover 7′, the washer 9′, the housing 6′ and the riveting plate 10′ are assembled together.

However, when using a pressing header rivets an end of the cam with the rivet plate together, the cam 8′ is easily not in alignment to the center of the riveting plate 10′, hence the engagement between the cam 8′ and the riveting plate 10′ is not reliable and stable. As a result, the riveting plate 8′ is prone to shed off, thus the connector operation can not go on.

In view of the above, a new electrical connector that overcomes the above-mentioned disadvantages is desired.

### SUMMARY OF THE INVENTION

An object of the present invention is to provide an assemble method about an electrical connector which can ensure a reliable electrical and mechanical connection.

To fulfill the above objects, an assembled method about an electrical connector in accordance with a preferred embodiment of the present invention is provided. The assembled method comprises the following steps: A. providing a housing received a plurality of terminals and defined a housing hole; B. providing a cover defined a cover hole thereof; C. mounting the cover on the housing and making the housing hole in alignment with the cover hole; D. providing a cam defined a end surface and a riveting plate for riveting the cam; E. inserting the cam into the cover hole, the housing hole and riveting hole in turn; F. using the pressing header riveting the end surface of the cam; in addition, the assemble method further comprises the step G: defining a recess with the shape similar to the shape of the pressing header.

as a improvement of the invention, the assembled method further comprises a washer disposed between the cam and the housing.

Relative to the conventional technology, the assembled method in according with the invention can avoid the problem that the pressing header is not prone to aim at the center of the cam by the recess disposed on the end surface of the cam, hence ensuring a stable slide about the cover relative to the housing. In addition, the washer added can improve a force character applied on the cover, which can enhance the slide stability of the cover relative to the housing.

Other objects, feature novels and advantages of the invention will become more apparent from the following detailed description when taken in conjunction with the accompanying drawings, in which:

### BRIEF DESCRIPTION OF THE DRAWINGS

FIG. 1 illustrates an exemplary perspective, exploded view of a conventional electrical connector;

FIG. 2 illustrates an exemplary, enlarged perspective, assembled view of the cam of FIG. 1, in another perspective;

FIG. 3 illustrates an isometric view of an electrical connector according to an embodiment of the present invention;

FIG. 4 illustrates an isometric view of an electrical connector shown in FIG. 3, in another perspective.

FIG. 5 illustrates an isometric, enlarged view of the cam shown in FIG. 4, in another perspective.

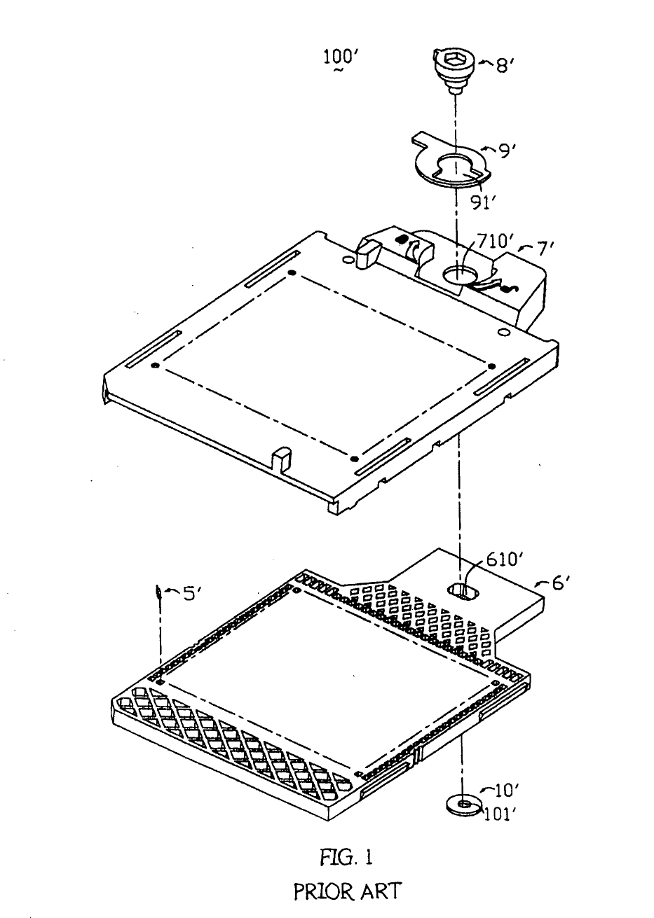

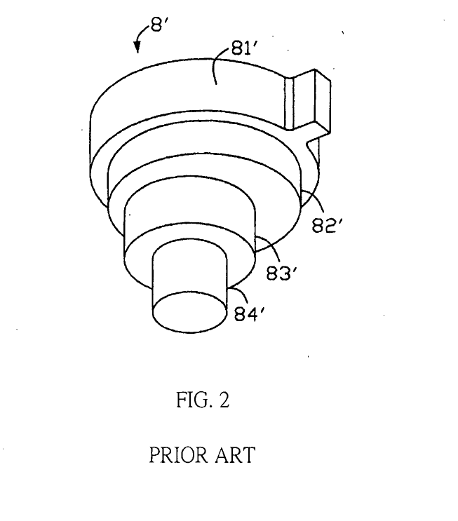

### DETAILED DESCRIPTION OF THE PREFERRED EMBODIMENT OF THE INVENTION

Reference will now be made to the drawings to describe the invention in detail.

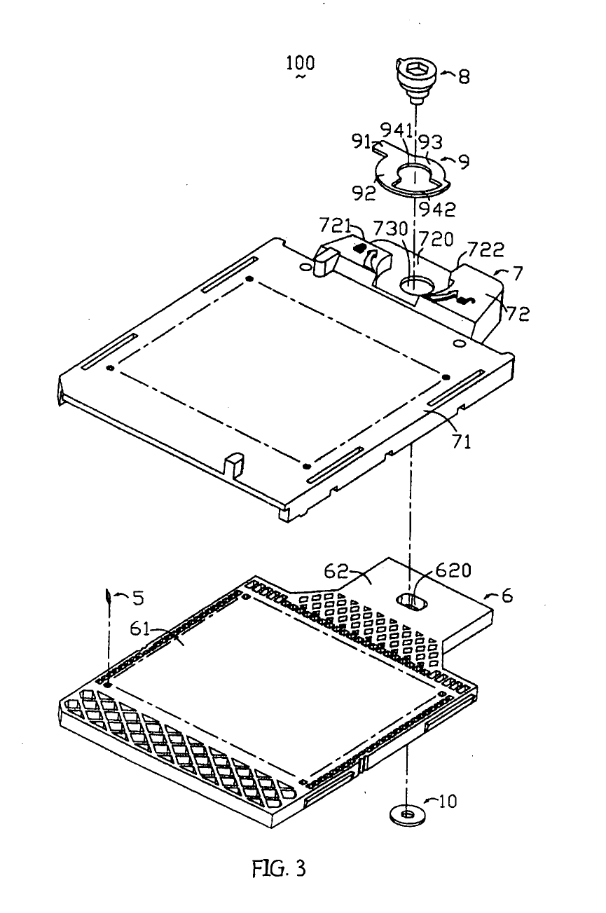

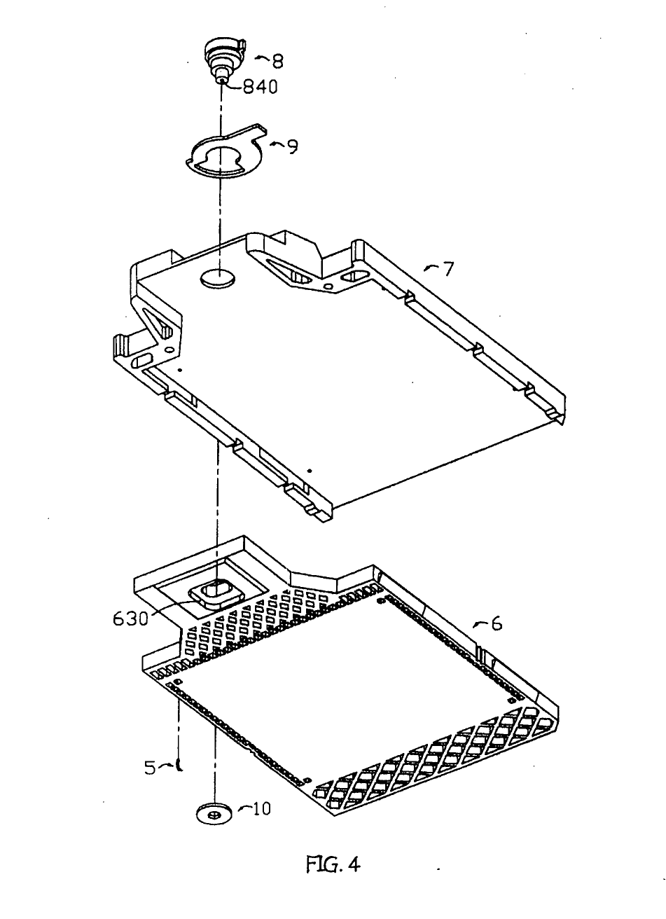

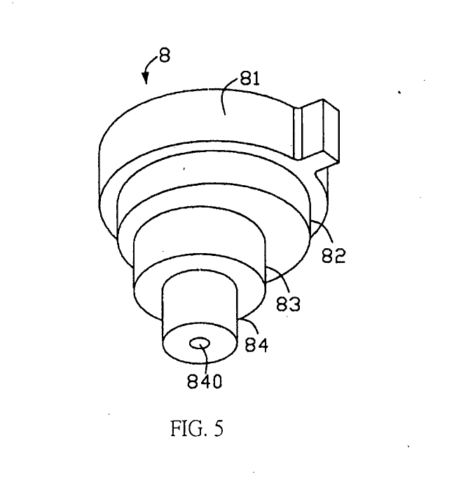

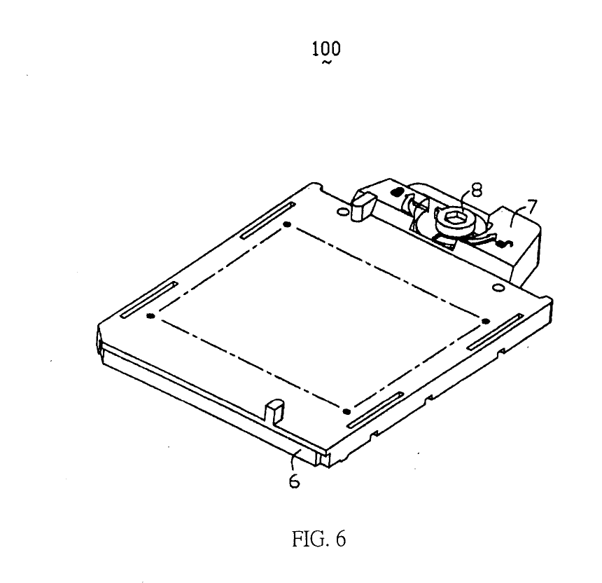

Referring to FIGS. 3-6, an electrical connector 100 assembled by the assembled method in accordance with the present invention comprises a dielectric housing 6, a cover 7 slidably mounted on the housing 6, and a multiplicity of terminals 5 received in corresponding passageways defined through the housing 6 for electrically connecting pins of a central processing unit (CPU) (not shown) with a mother board (not shown), a metallic cam 8 engaged between the housing 6 and the cover 7, and a riveting plate 10 defined a riveting hole therein and a washer 9 for engaging with the cam 8.

The housing 6 is generally in the shape of a square and comprises an insulative base portion 61 and a extending portion 62 extending from an end of the base portion 61. The extending portion 62 defines a through housing hole 620 for receiving the cam 8, and a receptacle hole 630 for receiving a washer 9 on a bottom thereof.

The cover 7 has a shape corresponding to that of the housing 6 and comprises an insulative body 71 and a ledge 72 defined at one end thereof. A multiplicity of passages extends through the body 61 in alignment with the passageways 13 of the housing 10. The ledge 72 defines a receiving section 720 for receiving the washer therein. In addition, the ledge 72 further defines a first stop wall 721 and a second stop wall 722 for engaging with cam 8. The receiving section 720 defines a cover hole 730 corresponding to the position of the housing hole 630 for receiving the corresponding section of the cam 8.

The cam 8 comprises an upper disk 81, a lower disk 82 and a lower cam block 83. The upper disk 81 is coaxial with the lower disk 82 and has a diameter larger than the lower disk 82. The upper disk 81 defines an elongated groove recessed in an upper surface thereof and comprises an outwardly protruding protrusion. The groove has two closed opposing longitudinal ends. Thus, a tool can be confinedly fitted into the groove to exert a rotation force on the cam 8, without the possibility that the tool may slid along the groove beyond the periphery of the upper disk 81. The cam block 83 is formed beneath the lower disk 82 and comprises a riveting end 44 coaxial with the cam block 83 at a lower end thereof. A rotational axis of the cam block 84 is offset from a rotational axis of the lower disk 82. The riveting end 84 defines a concave 840 in the center thereof according to the shape of a pressing header for riveting the riveting plate 10 onto the cam 8. When the riveting plate 10 engages with the cam 8, the pressing header is in alignment with the concave 840 of the cam 8, hence the riveting end 84 of the cam 8 is full with the riveting hole of the riveting plate 10, which makes the force of the engagement between the cam 8 and the riveting plate 10 more tightly and reliably.

The washer 9 is configured as a irregular shape and comprises a stop portion 91, an offset portion 92 and a receiving hole 93. During the cover 7 sliding relative to the housing 6, the stop portion 91 engages with the first stop wall 721 and the second wall 722 for preventing the cover 7 from excessively sliding relative to the housing 6. The offset portion 92 is used for pressing the cover 7 sliding on the housing 6.

Referring to FIGS. 3 to 6, in assembly, first, the terminals 5 are received in the passageways of the housing 10. Second, the cover 7 is assembled onto the housing 6. Successively, the cam 8 is mounted into the ZIF socket 1 from the top via the top cover holes 730 and then through the through housing holes 620. The cam block 84 of the cam 8 extends outwardly from the riveting plate 10. When using a pressing header rivets an end of the cam with the rivet plate together, the cam 9′ is easy to aim to the center of the riveting plate 10, due to the existence of the concave 840 , hence the riveting end 84 of the cam 8 is full with the riveting hole of the riveting plate 10 and the engagement between the cam 8 and the riveting plate 10 is reliable and stable.

From the foregoing it will be recognized that the principles of the invention may be employed in various arrangements to obtain the features, advantages and benefits described above. It is to be understood, therefore, that even though numerous characteristics and advantages of the invention have been set forth together with details of the structure and function of the invention, this disclosure is to be considered illustrative only. Various changes and modifications may be made in detail, especially in matters of size, shape and arrangements of parts, without departing from the spirit and scope of the invention as defined by the appended claims.

What is claimed is:

1. An assembled method comprising:
A. providing a housing received a plurality of terminals and defined a housing hole;
B. providing a cover having a cover hole corresponding to the housing hole;
C. mounting the cover on the housing and making the housing hole in alignment with the cover hole;
D. providing a cam for actuating the cover moving relative to the housing and a riveting plate defined a riveting hole for riveting the cam;
E. inserting the cam into the cover hole, the housing hole and the riveting hole in turn;
F. using the pressing header riveting an end portion of the cam;
in addition, the assemble method further comprises the step G: defining a recess with the shape similar to the shape of the pressing header.

2. The assembled method as claimed in claim 1, further comprising a washer disposed between the cam and the cover.

3. The assemble method as claimed in claim 2, wherein the washer comprises a stop portion and an offset portion.

4. The assemble method claimed in claim 1, the recess defined on a center position of the lower end of the cam.

5. The assemble method claimed in claim 1, wherein the cam comprises an upper disk, a lower disk and a lower cam block and the upper disk is coaxial with the lower disk and has a diameter larger than the lower disk.

6. A electrical connector comprising:
a housing received a plurality of terminals and defined a housing hole for receiving the cam;
a cover defined a cover hole in align with the housing hole for receiving the cam therein;
a cam for connecting the housing and the cover;
a riveting plate engaging with the cam;
wherein the cam defines a recess on a lower end thereof.

7. The assembled method as claimed in claim 6, further comprising a washer disposed between the cam and the cover.

8. The assemble method as claimed in claim 7, wherein the washer comprises a stop portion and an offset portion.

9. A electrical connector comprising:
an insulative housing received a plurality of terminals and defined a housing hole for receiving the cam;
a cover defined a cover hole in align with the housing hole for receiving the cam therein;
a cam extending into both the housing and the cover so as to move the cover relative to the housing, said cam defining an engagement periphery around a lower portion; and
a riveting plate defining an engagement hole for engagement with the engagement periphery of the cam; wherein
the cam defines around the lower portion an holding region which is configured to be able to be coupled to a corresponding portion of a pressing header during assembling the riveting plate to the cam without tilting.

10. The connector as claimed in claim 9, wherein said holding region is an upward recess from a bottom end surface of the cam.
